(19) United States
(12) Patent Application Publication
(10) Pub. No.: US 2006/0205379 A1
(43) Pub. Date: Sep. 14, 2006

(54) Signal reception enhancement apparatus, systems, and methods

(75) Inventor: Stewart S. Taylor, Beaverton, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 11/074,982

(22) Filed: Mar. 8, 2005

(51) Int. Cl. H04B 15/00; H04B 1/26

(52) U.S. Cl. 455/323; 455/313

(57) ABSTRACT

An apparatus and a system, as well as a method and an article, may include sensing a parameter value associated with noise in a mixer, such as the signal-to-noise ratio of a receiver, and adjusting the bias set-point of one or more mixer components in response to the sensed value of the parameter.

### TECHNICAL FIELD

Various embodiments described herein relate to the field of communications generally, including apparatus, systems, and methods for receiving signals.

### BACKGROUND INFORMATION

In some receivers, mixer operation may introduce noise, such as flicker noise, in the baseband signal processing section. The presence of flicker noise in direct conversion (e.g., zero intermediate frequency, or ZIF) receivers and very low intermediate frequency (VLIF) receivers may significantly degrade noise figure performance, as well as sensitivity. While the use of dual-mixer circuit topologies may reduce flicker noise effects, design tradeoffs may include increased complexity, die area, and power consumption.

### BRIEF DESCRIPTION OF THE DRAWINGS

FIG. 1 is a block diagram of an apparatus and a system according to various embodiments;

FIG. 2 is a flow chart illustrating several methods according to various embodiments; and

FIG. 3 is a block diagram of an article according to various embodiments.

### DETAILED DESCRIPTION

Various embodiments disclosed herein may address some of the challenges described above by using communications equipment baseband signal processing to sense the presence of noise, such as flicker noise. The noise may be sensed directly or indirectly, and then a bias set-point in the mixer can be adjusted to reduce the noise figure, and/or increase sensitivity, for example.

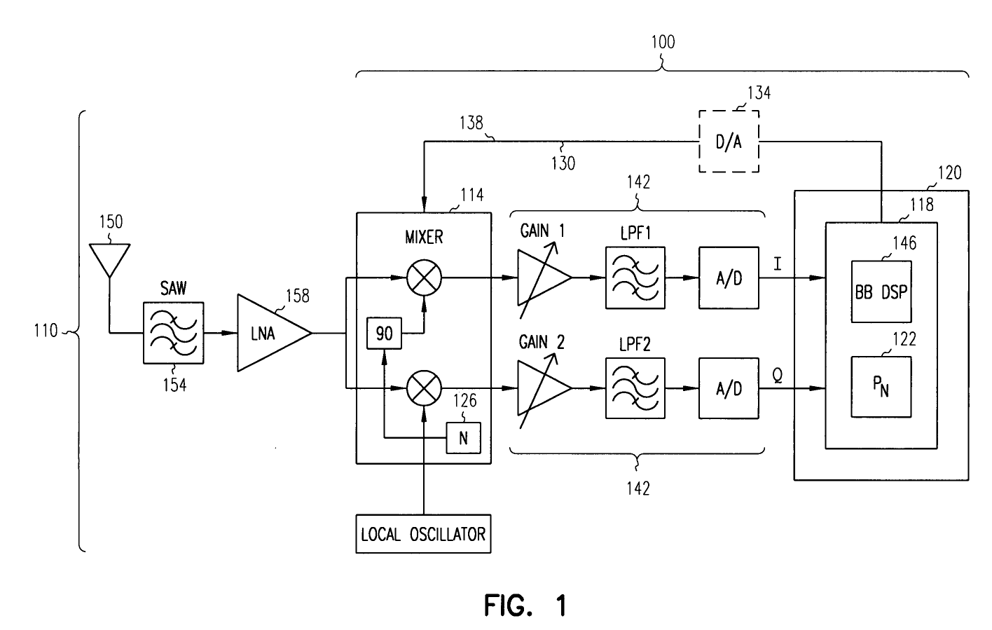

FIG. 1 is a block diagram of an apparatus 100 and a system 110 according to various embodiments. The basic approach illustrated therein may benefit many types of receivers, including receivers having complementary metal-oxide semiconductor (CMOS) components. This is because some CMOS passive mixers exhibit reduced flicker noise at certain bias current values, perhaps due to self-mixing of the local oscillator via gate-to-drain capacitance feedthrough. Thus, if a selected amount of current is present in the mixer transistor(s), flicker noise may be reduced. However, the optimal amount of current may vary. Therefore, it may be useful to adjust the current (or other mixer bias set-point) based on monitored noise parameters provided by the digital baseband circuitry so as to enhance sensitivity, or to reduce flicker noise and noise figure.

For the purposes of this document, a VLIF receiver is a receiver having an intermediate frequency of less than about 150 kilohertz. “Noise figure” should be understood to comprise the ratio of the noise power at the output of a device to the noise power at the input of the device due to the source, reduced by the system gain, where the input noise temperature is equal to a reference noise temperature (e.g., approximately 293 K). “Flicker noise” may be understood to include noise having a power spectrum that varies approximately inversely with the frequency. For more information regarding the different types of noise that may be present in mixers, please refer to Analysis and Modeling of Low-Frequency Noise in Resistive FET Mixers by Michael Margraf, et al., IEEE Transactions on Microwave Theory and Techniques, Pgs. 1709-1718, Vol. 52, No. 7, July 2004.

Thus, continuing with FIG. 1, it can be seen that an apparatus 100 may include a mixer 114 and a measurement module 118 (e.g., forming a portion of the digital baseband circuitry 120) to sense a parameter value 122 associated with noise 126, perhaps comprising flicker noise, in the mixer 114, which may comprise a passive mixer. The parameter value 122 may comprise a signal-to-noise ratio, a noise figure, and/or the noise amplitude, among others. The measurement module 118 may then be used to provide a control signal 130, directly or indirectly, to the mixer 114 in response to the parameter value 122.

For example, the apparatus 100 may include a conversion circuit 134 to receive the control signal 130 and provide a bias set-point 138 as the control signal 130 (or in response to the control signal 130) to the mixer 114. The conversion circuit 134 may include any number of elements, such as a digital-to-analog converter, among others. The bias set-point 138 may also comprise a number of parameters, such as a bias set-point current, and/or a bias set-point voltage. Cost savings and/or improved integration may be achieved in some embodiments if one or more portions of the mixer 114 are formed using complementary metal-oxide semiconductor (CMOS) circuitry.

In some embodiments, the apparatus 100 may include a pair of signal chains 142 to convey an in-phase signal I and a quadrature signal Q to the measurement module 118. The measurement module 118, in turn, may include a digital signal processor 146 to receive the in-phase signal I and the quadrature signal Q from the mixer 114. In some embodiments, either or both of these signals I, Q may be processed to sense the presence of noise 126 in the mixer 114.

Yet other embodiments may be realized. For example, a system 110 may include one or more of the apparatus 100 described previously, as well as an antenna 150, including an omnidirectional, monopole, dipole, and/or patch antenna coupled to the mixer 114. The system 110 may also include a filter 154 (e.g., a surface acoustic wave filter) and an amplifier 158 (e.g., a low noise amplifier) to couple the antenna 150 to the mixer 114. The measurement module 118 may be included in a baseband signal processing circuit 120 of a receiver, such as a cellular telephone receiver, or a wireless local area network (WLAN) receiver.

Any of the components previously described can be implemented in a number of ways, including simulation via software. Thus, the apparatus 100, system 110, mixer 114, measurement module 118, baseband circuitry 120, parameter value 122, noise 126, control signal 130, conversion circuit 134, bias set-point 138, signal chains 142, signal processor 146, antenna 150, filter 154, amplifier 158, and signals I and Q may all be characterized as “modules” herein. Such modules may include hardware circuitry, and/or a processor and/or memory circuits, software program modules and objects, and/or firmware, and combinations thereof, as desired by the architect of the apparatus 100 and systems 110, and as appropriate for particular implementations of various embodiments. For example, such modules may be included in a software-defined radio, or a system operation simulation package, such as a software electrical signal simulation package, a transmission/reception simulation package, a power usage and distribution simulation package, a capacitance-inductance simulation package, a power/heat dissipation simulation package, and/or a combination of software and hardware used to simulate the operation of various potential embodiments.

It should also be understood that the apparatus and systems of various embodiments can be used in applications other than for direct conversion and VLIF receivers, and thus, various embodiments are not to be so limited. The illustrations of apparatus 100 and systems 110 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others.

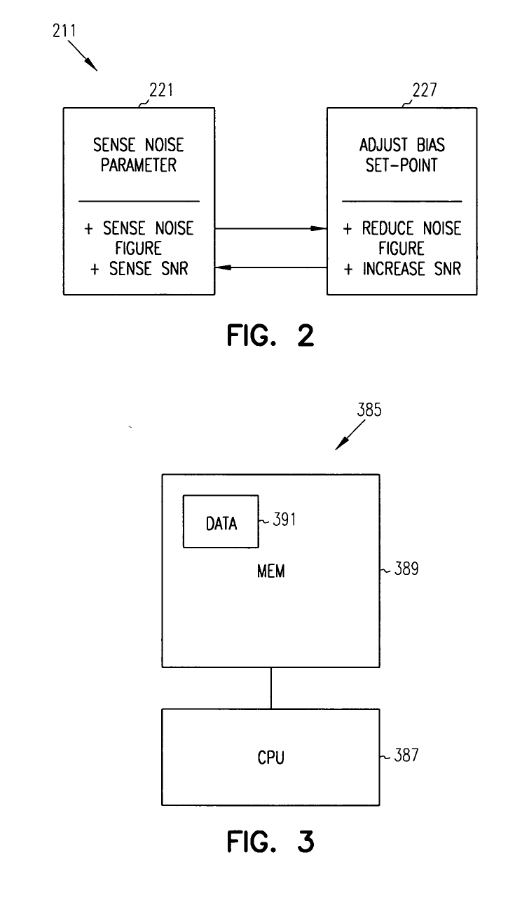

Some embodiments include a number of methods. For example, FIG. 2 is a flow chart illustrating several methods 211 according to various embodiments. Thus, a method 211 may begin at block 221 with sensing a parameter value associated with noise, perhaps comprising flicker noise, in a mixer. Sensing the parameter value associated with the noise may further include sensing a signal-to-noise ratio and/or sensing a noise figure, for example.

The method 211 may continue at block 227 with adjusting a bias set-point of one or more components in the mixer in response to the parameter value. For example, the bias set-point may be adjusted to reduce a noise figure, and/or to increase a signal-to-noise ratio. Sensing and adjustment at blocks 221, 227 may comprise a static process (e.g., enacted once upon equipment power-up), or a dynamic process (e.g., wherein one or more bias set-points are periodically or continuously adjusted in response to one or more sensed noise parameters).

In some embodiments, the bias set-point of one or more components in a mixer of a direct conversion receiver, or a VLIF receiver may be adjusted. In some embodiments, the bias set-point of one or more mixer components in a cellular telephone may be adjusted. As noted previously, mixer components may include transistors, such that the bias set-point comprises a current in one or more transistors.

It should be noted that the methods described herein do not have to be executed in the order described, or in any particular order. Moreover, various activities described with respect to the methods identified herein can be executed in repetitive, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java, Smalltalk, or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment, including Hypertext Markup Language (HTML) and Extensible Markup Language (XML). Thus, other embodiments may be realized.

FIG. 3 is a block diagram of an article 385 according to various embodiments, such as a computer, a memory system, a magnetic or optical disk, some other storage device, and/or any type of electronic device or system. The article 385 may include a processor 387 coupled to a machine-accessible medium such as a memory 389 (e.g., a memory including an electrical, optical, or electromagnetic conductor) having associated information 391 (e.g., computer program instructions and/or data), which, when accessed, results in a machine (e.g., the processor 387) performing such actions as sensing a parameter value associated with noise (e.g., flicker noise) in a mixer, and adjusting the bias set-point of one or more components of the mixer in response to the parameter value. Sensing the parameter value associated with the noise may further include sensing a signal-to-noise ratio, as well as sensing a noise figure.

Implementing the apparatus, systems, and methods disclosed herein may result in practical implementation of direct conversion receivers in CMOS technology, including cellular telephones. The mechanisms described herein may also operate to improve the sensitivity of VLIF receiver systems and WLAN products.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those skilled in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, including:
a mixer; and
a measurement module to sense a parameter value associated with noise in the mixer and to provide a control signal to the mixer in response to the parameter value.

2. The apparatus of claim 1, wherein the noise comprises flicker noise.

3. The apparatus of claim 1, further including:
a conversion circuit to receive the control signal and to provide a bias set-point responsive to the control signal.

4. The apparatus of claim 3, wherein the bias set-point comprises one of a bias set-point current and a bias set-point voltage.

5. The apparatus of claim 1, wherein the mixer comprises a passive mixer.

6. The apparatus of claim 3, wherein the conversion circuit includes a digital to analog converter.

7. The apparatus of claim 1, wherein at least a portion of the mixer is formed using complementary metal-oxide semiconductor (CMOS) circuitry.

8. The apparatus of claim 1, wherein the measurement module includes:
a digital signal processor to receive an in-phase signal I and a quadrature signal Q from the mixer.

9. The apparatus of claim 1, wherein the parameter value comprises a signal-to-noise ratio.

10. The apparatus of claim 1, wherein the parameter value comprises a noise figure.

11. The apparatus of claim 1, wherein the parameter value comprises an amplitude of the noise.

12. A system, including:
a mixer;
a measurement module to sense a parameter value associated with noise in the mixer and to provide a control signal to the mixer in response to parameter value; and
an omnidirectional antenna coupled to the mixer.

13. The system of claim 12, further including:
a pair of signal chains to convey an in-phase signal I and a quadrature signal Q to the measurement module.

14. The system of claim 12, further including:
a filter and an amplifier to couple the omnidirectional antenna to the mixer.

15. The system of claim 12, wherein the measurement module is included in a baseband signal processing circuit of a receiver.

16. The system of claim 12, wherein the parameter value comprises a signal-to-noise ratio.

17. The system of claim 12, wherein the parameter value comprises a noise figure.

18. The system of claim 12, wherein the parameter value comprises an amplitude of the noise.

19. The system of claim 12, wherein the noise comprises flicker noise.

20. A method, including:
sensing a parameter value associated with noise in a mixer; and
adjusting a bias set-point of at least one component of the mixer in response to the parameter value.

21. The method of claim 20, further including:
adjusting the bias set-point to reduce a noise figure.

22. The method of claim 20, further including:
adjusting the bias set-point to increase a signal-to-noise ratio.

23. The method of claim 20, wherein the at least one mixer component comprises a transistor, and wherein the bias set-point comprises a current in the transistor.

24. The method of claim 20, further including:
adjusting the bias set-point of the at least one component of the mixer in a direct conversion receiver.

25. The method of claim 20, further including:
adjusting the bias set-point of the at least one component of the mixer in a very low intermediate-frequency receiver.

26. The method of claim 20, further including:
adjusting the bias set-point of the at least one component of the mixer in a cellular telephone.

27. The method of claim 20, wherein the noise comprises flicker noise.

28. An article including a machine-accessible medium having associated information, wherein the information, when accessed, results in a machine performing:
sensing a parameter value associated with noise in a mixer; and
adjusting a bias set-point of at least one component of the mixer in response to the parameter value.

29. The article of claim 28, wherein sensing the parameter value associated with the noise further includes:
sensing a signal-to-noise ratio.

30. The article of claim 28, wherein sensing the parameter value associated with the noise further includes:
sensing a noise figure.
